(19) United States
(12) Patent Application Publication
(10) Pub. No.: US 2025/0237569 A1
(43) Pub. Date: Jul. 24, 2025

(54) LIQUID LEAKAGE DETECTION BAND

(71) Applicant: SHENZHEN ENVICOOL TECHNOLOGY CO., LTD., Shenzhen (CN)

(72) Inventors: Xiaoxin XU, Shenzhen (CN); Xiaolei AI, Shenzhen (CN); Xiaojin CHENG, Shenzhen (CN)

(73) Assignee: SHENZHEN ENVICOOL TECHNOLOGY CO., LTD., Shenzhen (CN)

(21) Appl. No.: 18/805,939

(22) Filed: Aug. 15, 2024

(30) Foreign Application Priority Data
Jan. 19, 2024 (CN) 202420144197.5

(51) Int. Cl. G01M 3/16

(52) U.S. Cl. CPC G01M 3/165

(57) ABSTRACT

A liquid leakage detection band includes a base band, a first liquid leakage detection wire and a second liquid leakage detection wire. The first liquid leakage detection wire and the second liquid leakage detection wire are distributed on the base band and spaced apart from each other. The first liquid leakage detection wire and the second liquid leakage detection wire extend from a first end of the base band to a second end of the base band, and return back to the first end of the base band, where the first end and the second end of the base band refer to two ends of the base band away from each other in a length direction of the base band. That is, two ends of the first liquid leakage detection wire and the second liquid leakage detection wire are located at a same end of the base band.

### CROSS REFERENCE TO RELATED APPLICATIONS

This application claims the priorities to Chinese patent application No. 202420144197.5, titled “LIQUID LEAKAGE DETECTION BAND”, filed with the China National Intellectual Property Administration Jan. 19, 2024, the entire disclosure of which is hereby incorporated by reference.

### FIELD

The present application relates to the technical field of liquid cooling devices, and in particular to a liquid leakage detection band.

### BACKGROUND

A server generates a huge amount of heat during operation. In order to ensure the normal operation of the server, a cooling device is needed to dissipate the heat of the server. The cooling device generally falls into two categories: an air cooling device and a liquid cooling device. The liquid cooling device is widely used due to its advantages of fast heat dissipation, low noise and energy consumption, and good applicability to environments.

Liquid leakage may occur during the operation of the liquid cooling device. Once the liquid leakage contacts an electronic element of the server, the electronic element and even the entire server may be damaged, causing severe results such as data loss.

A liquid leakage detection band is mainly used for liquid leakage detection at present. Two ends of the liquid leakage detection band are each provided with a connector. In use, one of the connectors is connected to a liquid leakage detector. Then, the other of the connectors is far away from the liquid leakage detector, and, an additional wire is needed to connect the other of the connectors to the liquid leakage detector, or, the liquid leakage detection band is bent so as to make the two connectors at a same side. As a result, wiring of the liquid leakage detector is messy. Therefore, due to the structure itself, the current liquid leakage detection band not only is difficult to be connected and disconnected but also is inconvenient to be maintained.

### SUMMARY

A liquid leakage detection band is provided according to the present application to effectively facilitate connection and disconnection thereof.

A liquid leakage detection band includes a base band, a first liquid leakage detection wire and a second liquid leakage detection wire,
the first liquid leakage detection wire and the second liquid leakage detection wire are distributed on the base band and are spaced apart from each other; and
the first liquid leakage detection wire and the second liquid leakage detection wire extend from a first end of the base band to a second end of the base band, and return back to the first end of the base band, and the first end and the second end of the base band refer to two ends of the base band away from each other in a length direction of the base band.

In some embodiments, the first end of the base band is provided with a first extension portion and a second extension portion, a first terminal of the first liquid leakage detection wire and the second liquid leakage detection wire is located on the first extension portion, and a second terminal of the first liquid leakage detection wire and the second liquid leakage detection wire is located on the second extension portion.

In some embodiments, the first extension portion and the second extension portion are parallel to each other.

In some embodiments, an arc transition is provided at a junction of the first extension portion and the base band, and another arc transition is provided at a junction of the second extension portion and the base band.

In some embodiments, at least one first detection sheet is provided at a side of the first liquid leakage detection wire towards the second liquid leakage detection wire, and/or at least one second detection sheet is provided at a side of the second liquid leakage detection wire towards the first liquid leakage detection wire.

In some embodiments, the at least one first detection sheet and the at least one second detection sheet are arranged alternatively, and a preset distance is present between the at least one first detection sheet and the at least one second detection sheet.

In some embodiments, the base band is provided with a first break detection wire and a second break detection wire;
the first break detection wire is located at a side of the first liquid leakage detection wire away from the second liquid leakage detection wire, and the second break detection wire is located at a side of the second liquid leakage detection wire away from the first liquid leakage detection wire; and
the first break detection wire and the second break detection wire extend from the first end of the base band to the second end of the base band, and return back to the first end of the base band.

In some embodiments, the first liquid leakage detection wire is provided with a first splice sheet, and the second liquid leakage detection wire is provided with a second splice sheet;
the first splice sheet and the second splice sheet extend towards each other, and are spaced apart by a preset gap; and
the base band, the first liquid leakage detection wire and the second liquid leakage detection wire can be cut along a body of the first splice sheet and a body of the second splice sheet.

In some embodiments, a cutting mark line is provided on the base band, and the cutting mark line passes through the body of the first splice sheet and the body of the second splice sheet.

In some embodiments, the first splice sheet includes two first splice sub-sheets that are distributed along a length direction of the first liquid leakage detection wire and are spaced apart from each other, and the second splice sheet includes two second splice sub-sheets that are distributed along a length direction of the second liquid leakage detection wire and are spaced apart from each other; and

the base band, the first liquid leakage detection wire, and the second liquid leakage detection wire can be cut between the two first splice sub-sheets and between the two second splice sub-sheets.

Compared with the prior art, the above technical solutions have the following advantages.

With the liquid leakage detection band according to the present application, the first liquid leakage detection wire and the second liquid leakage detection wire extend from the first end of the base band to the second end of the base band, and return back to the first end of the base band. In this way, when the liquid leakage detection band is being connected to a liquid leakage detector, there is no need to bend two ends of the liquid leakage detection band to a same end or connect an end of the liquid leakage detection band away from the liquid leakage detector to the liquid leakage detector by an additional wire. Therefore, connection and disconnection of the liquid leakage detection band are effectively facilitated, and wiring of the liquid leakage detection band is less messy, thereby making maintenance easier.

### BRIEF DESCRIPTION OF THE DRAWINGS

For more clearly illustrating embodiments of the present application or the technical solutions in the prior art, drawings referred to describe the embodiments or the prior art will be briefly described hereinafter. Apparently, the drawings in the following descriptions are only examples of the present application, and for those skilled in the art, other drawings may be obtained based on these drawings without any creative efforts.

FIG. 1 is a schematic structural view of a liquid leakage detection band according to an embodiment of the present application;

FIG. 2 is a schematic structural view of a liquid leakage detection band according to another embodiment of the present application; and

FIG. 3 is a schematic structural view of the liquid leakage detection band in FIG. 2 that can be cut.

### REFERENCE NUMERALS

| | | | |
|---|---|---|---|
| 10 | base band, | 11 | first extension portion, |
| 12 | second extension portion, | 13 | extension end, |
| 20 | first liquid leakage detection wire, | | |
| 21 | first detection sheet, | 22 | first splice sheet, |
| 30 | second liquid leakage detection wire, | | |
| 31 | second detection sheet, | 32 | second splice sheet, |
| 40 | first break detection wire, | 50 | second break detection |
| 60 | first terminal, | 70 | second terminal, |
| 80 | connector. | | |

### Detailed Description of the Embodiments

Technical solutions according to the embodiments of the present application will be described clearly and completely as follows in conjunction with the accompany drawings in the embodiments of the present application. It is obvious that the described embodiments are only a part of the embodiments of the present application, rather than all of the embodiments. All the other embodiments obtained by those skilled in the art based on the embodiments in the present application without any creative work belong to the scope of protection of the present application.

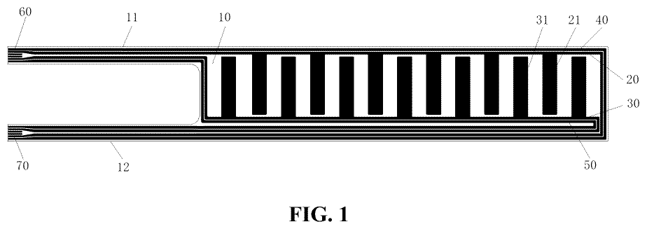

Referring to FIG. 1, a liquid leakage detection band is provided according to an embodiment of the present application. The liquid leakage detection band includes a base band 10, a first liquid leakage detection wire 20 and a second liquid leakage detection wire 30. The first liquid leakage detection wire 20 and the second liquid leakage detection wire 30 are distributed on the base band 10 and spaced apart from each other. The base band 10 may be a flexible band. When the liquid leakage detection band is applied to liquid leakage detection of a liquid supply pipeline, a protection pipe may be mounted outside the liquid supply pipeline, and the liquid leakage detection band is attached to an inner wall of the protection pipe. The liquid leakage detection band may be arranged parallel to an axial direction of the protection pipe, or may be arranged on the inner wall of the protection pipe in a spiral manner along the axial direction of the protection pipe. Therefore, the liquid leakage detection band is easy to be arranged inside the protection pipe if the base band 10 is a flexible band. If the liquid cooling device is provided with a liquid collection groove for liquid leakage collection, the flexible band may be laid on an inner bottom surface of the liquid collection groove. The liquid leakage detection band may be S-shaped inside the liquid collection groove. The first liquid leakage detection wire 20 and the second liquid leakage detection wire 30 may be formed on the base band 10 by electroplating. The base band 10 may be strip-shaped. The first liquid leakage detection wire 20 and the second liquid leakage detection wire 30 may be straight, zigzag, or wavy, as long as the first liquid leakage detection wire 20 and the second liquid leakage detection wire 30 are spaced apart from each other. The first liquid leakage detection wire 20 and the second liquid leakage detection wire 30 extend from a first end of the base band 10 to a second end of the base band 10, and return back to the first end of the base band 10, where the first end and the second end of the base band 10 refer to two ends of the base band 10 away from each other in a length direction of the base band 10. That is, two ends of the first liquid leakage detection wire 20 and the second liquid leakage detection wire 30 are located at a same end of the base band 10. When the liquid leakage detection band is connected to a liquid leakage detector, there is no need to bend two ends of the liquid leakage detection band to a same end or connect an end of the liquid leakage detection band away from the liquid leakage detector to the liquid leakage detector by an additional wire. Therefore, connection and disconnection of the liquid leakage detection band are effectively facilitated, and wiring of the liquid leakage detection band is less messy, thereby making maintenance easier.

In some embodiments, the first end of the base band 10 is provided with a first extension portion 11 and a second extension portion 12. As shown in FIG. 1, the first extension portion 11 and the second extension portion 12 is provided at a left end of the base band 10 and extend leftwards. A width of the first extension portion 11 and a width of the second extension portion 12 are smaller than a width of a body of the base band 10. The first extension portion 11 and the second extension portion 12 may be parallel or not parallel to each other. A first terminal 60 of the first liquid leakage detection wire 20 and the second liquid leakage detection wire 30 is located on the first extension portion 11, and a second terminal 70 of the first liquid leakage detection wire 20 and the second liquid leakage detection wire 30 is located on the second extension portion 12. With the first extension portion 11 and the second extension portion 12, the first terminal 60 and the second terminal 70 become more flexible. For example, when a distance between two connectors of the liquid leakage detector in correspondence to the first extension portion 60 and the second extension portion 70 is larger than or smaller than a distance between the first terminal 60 and the second terminal 70, the first terminal 60 and/or the second terminal 70 are bent to adapt the connectors of the liquid leakage detector. To make the first extension portion 11 and the second extension portion 12 easy to be bent, an arc transition is provided at a junction of the first extension portion 11 and the base band 10, and another arc transition is provided at a junction of the second extension portion 12 and the base band 10. As shown in FIG. 1, the arc transition is provided at a right angle between a right end of the first extension portion 11 and a left end of the base band 10, and the another arc transition is provided at another right angle between a right end of the second extension portion 12 and the left end of the base band 10.

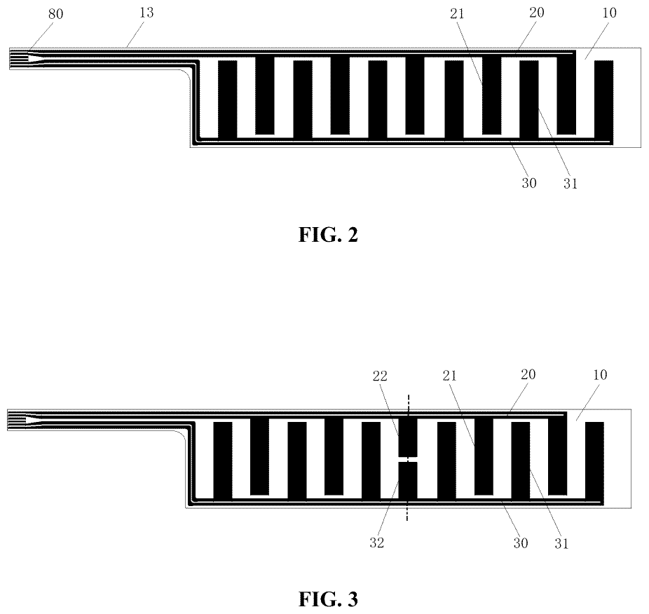

In some embodiments, after extending from the first end to the second end of the base band 10, the first liquid leakage detection wire 20 may be bent towards the second liquid leakage detection wire 30, and then towards the first end of the base band 10. After extending from the first end to the second end of the base band 10, the second liquid leakage detection wire 30 may be bent away from the first liquid leakage detection wire 20, and then towards the first end of the base band 10. The arrangement after bending is shown in FIG. 1. This arrangement is applicable to a structure where the liquid leakage detection band has the first terminal 60 and the second terminal 70. Alternatively, after extending from the first end to the second end of the base band 10, the first liquid leakage detection wire 20 may be bent away from the second liquid leakage detection wire 30, and then towards the first end of the base band 10. After extending from the first end to the second end of the base band 10, the second liquid leakage detection wire 30 may be bent away from the first liquid leakage detection wire 20, and then towards the first end of the base band 10. That is, both the first liquid leakage detection wire 20 and the second liquid leakage detection wire 30 are bent by 180 degrees at the second end. The two ends of the first liquid leakage detection wire 20 and the second liquid leakage detection wire 30 are combined to form one connector 80. The arrangement after bending is shown in FIGS. 2 and 3. The first end of the base band 10 is provided with an extension end 13, and the connector 80 is arranged on the extension end 13.

In some embodiments, at least one first detection sheet 21a is provided at a side of the first liquid leakage detection wire 20 towards the second liquid leakage detection wire 30, and/or at least one second detection sheet 31a is provided at a side of the second liquid leakage detection wire 30 towards the first liquid leakage detection wire 20. The detection sheet of the liquid leakage detection band has three distribution manners. In a first manner, only the first detection sheet 21 is provided at the side of the first liquid leakage detection wire 20. In a second manner, only the second detection sheet 31 is provided at the side of the second liquid leakage detection wire 30. In a third manner, the first detection sheet 21 is provided at the side of the first liquid leakage detection wire 20 and the second detection sheet 31 is provided at the side of the second liquid leakage detection wire 30 at the same time. The first detection sheet 21 does not contact the second detection sheet 31, the first detection sheet 21 does not contact the second liquid leakage detection wire 30, and the second detection sheet 31 does not contact the first liquid leakage detection wire 20. During detection, the liquid leakage problem can be detected when leakage liquid contacts the first detection sheet 21 and the second detection sheet 31 at the same time, or, contacts the first detection sheet 21 and the second liquid leakage detection wire 30 at the same time, or, contacts the second detection sheet 31 and the first liquid leakage detection wire 20 at the same time, or contacts the first liquid leakage detection wire 20 and the second liquid leakage detection wire 30 at the same time. Therefore, the precision of liquid leakage detection is effectively improved when compared with a current solution that the liquid leakage is detected only by the first liquid leakage detection wire 20 and the second liquid leakage detection wire 30.

In some embodiments, the at least one first detection sheet 21 and the at least one second detection sheet 31 are arranged alternatively, and a preset distance is present between the at least one first detection sheet 21 and the at least one second detection sheet 31. As shown in FIG. 1, the first detection sheet 21 and the second detection sheet 31 are distributed in a comb shape. A width of the first detection sheet 21 and a width of the second detection sheet 31 may be larger than, smaller than or equal to half of a distance between the first liquid leakage detection wire 20 and the second liquid leakage detection wire 30. It should be noted that, the first detection sheet 21 and the second detection sheet 31 shown in FIGS. 1, 2 and 3 are each of a rectangular structure. Besides, the first detection sheet 21 and the second detection sheet 31 may be triangular, trapezoidal, L-shaped, T-shaped or the like, as long as the first detection sheet 21 extends towards the second liquid leakage detection wire 30, and the second detection sheet 31 extends towards the first liquid leakage detection wire 20.

In some embodiments, as shown in FIG. 1, the base band 10 is provided with a first break detection wire 40 and a second break detection wire 50. The first break detection wire 40 is located at a side of the first liquid leakage detection wire 20 away from the second liquid leakage detection wire 30, and the second break detection wire 50 is located at a side of the second liquid leakage detection wire 30 away from the first liquid leakage detection wire 20. The first break detection wire 40 and the second break detection wire 50 extend from the first end of the base band 10 to the second end of the base band 10, and return back to the first end of the base band 10. The first break detection wire 40 is used for detecting whether the first liquid leakage detection wire 20 is broken, and the second break detection wire 50 is used for detecting whether the second liquid leakage detection wire 30 is broken. In this way, the first liquid leakage detection wire 20 and the second liquid leakage detection wire 30 can be repaired in time after broken, thereby improving the detection precision of the liquid leakage detector.

In some embodiments, as shown in FIG. 3, the first liquid leakage detection wire 20 is provided with a first splice sheet 22, and the second liquid leakage detection wire 30 is provided with a second splice sheet 32. The first splice sheet 22 and the second splice sheet 32 extend towards each other, and are spaced apart by a preset gap. When the leakage liquid contacts the first splice sheet 22 and the second splice sheet 32 at the same time, the liquid leakage detection can also be performed. The base band 10, the first liquid leakage detection wire 20 and the second liquid leakage detection wire 30 can be cut along a body of the first splice sheet 22 and a body of the second splice sheet 32. Multiple sets of first splice sheets 22 and second splice sheets 32 may be provided along a length direction of the liquid leakage detection band. When the liquid leakage detection band is relatively long, the band can be cut along the body of the first splice sheet 22 and the body of the second splice sheet 32. When the liquid leakage detection band is relatively short, another longer liquid leakage detection band can be spliced at a position where the band is cut. Therefore, requirements for the liquid leakage detection of different lengths can be satisfied, and the applicability of the liquid leakage detection band is effectively enhanced. Moreover, there is no need to customize a liquid leakage detection band with a corresponding length according to the length of the liquid leakage detection. For example, when the liquid leakage detection is to be performed on the liquid supply pipeline of the liquid cooling device, the existing liquid leakage detection band has to be customized according to a length of the liquid supply pipeline. With the liquid leakage detection band according to the present application that can be cut, on the contrary, the liquid leakage detection band can be cut or spliced according to the length of the liquid supply pipeline, thereby reducing the customization cost.

In some embodiments, to easily cut the liquid leakage detection band, a cutting mark line is provided one the base band 10. The cutting mark line may be an indentation provided on the liquid leakage detection band, or a line that has a color and is easy to identify. As shown in FIG. 3, the cutting mark line passes through the body of the first splice sheet 22 and the body of the second splice sheet 32. In use, a user may clip or break the liquid leakage detection band along the cutting mark line according to needs. In this way, the cutting is prevented from being misaligned, and it becomes easier for the user to find the position for cutting, thereby increasing the cutting efficiency.

In some embodiments, the first splice sheet 22 includes two first splice sub-sheets that are distributed along a length direction of the first liquid leakage detection wire 20 and are spaced apart from each other, and the two first splice sub-sheets are preferably of a same size. The second splice sheet 32 includes two second splice sub-sheets that are distributed along a length direction of the second liquid leakage detection wire 30 and are spaced apart from each other, and the two first splice sub-sheets are preferably of a same size. The base band 10, the first liquid leakage detection wire 20, and the second liquid leakage detection wire 30 can be cut between the two first splice sub-sheets and between the two second splice sub-sheets. The two first splice sheets 22 are spaced apart, and the two second splice sheets 32 are spaced apart. In this way, a problem is prevented that, after the liquid leakage detection band is cut, a first liquid leakage detection splice and a second liquid leakage detection splice on one segment have a relatively small area, while a first liquid leakage detection splice and a second liquid leakage detection splice on the other one segment have a relatively large area.

It should be noted that, in this specification, relational terms such as “first” and “second” are merely intended to distinguish one entity from other entities, and do not require or imply any actual relationships or sequences among these entities.

The above embodiments in this specification are described in a progressive manner. Each of the embodiments is mainly focused on describing its differences from other embodiments, and references may be made among these embodiments with respect to the same or similar portions among these embodiments.

The liquid leakage detection band according to the present application is described in detail hereinbefore. The principle and the embodiments of the present application are illustrated herein by specific examples. The above description of examples is only intended to help the understanding of the method and the idea of the present application. It should be noted that, for those skilled in the art, a few of modifications and improvements may be made to the present application without departing from the principle of the present application, and these modifications and improvements are deemed to fall into the protection scope of the present application defined by the claims.

1. A liquid leakage detection band, comprising a base band, a first liquid leakage detection wire and a second liquid leakage detection wire, wherein
the first liquid leakage detection wire and the second liquid leakage detection wire are distributed on the base band and are spaced apart from each other; and
the first liquid leakage detection wire and the second liquid leakage detection wire extend from a first end of the base band to a second end of the base band, and return back to the first end of the base band, wherein the first end and the second end of the base band refer to two ends of the base band away from each other in a length direction of the base band.

2. The liquid leakage detection band according to claim 1, wherein the first end of the base band is provided with a first extension portion and a second extension portion, a first terminal of the first liquid leakage detection wire and the second liquid leakage detection wire is located on the first extension portion, and a second terminal of the first liquid leakage detection wire and the second liquid leakage detection wire is located on the second extension portion.

3. The liquid leakage detection band according to claim 2, wherein the first extension portion and the second extension portion are parallel to each other.

4. The liquid leakage detection band according to claim 2, wherein an arc transition is provided at a junction of the first extension portion and the base band, and another arc transition is provided at a junction of the second extension portion and the base band.

5. The liquid leakage detection band according to claim 1, wherein at least one first detection sheet is provided at a side of the first liquid leakage detection wire towards the second liquid leakage detection wire, and/or at least one second detection sheet is provided at a side of the second liquid leakage detection wire towards the first liquid leakage detection wire.

6. The liquid leakage detection band according to claim 5, wherein the at least one first detection sheet and the at least one second detection sheet are arranged alternatively, and a preset distance is present between the at least one first detection sheet and the at least one second detection sheet.

7. The liquid leakage detection band according to claim 1, wherein
the base band is provided with a first break detection wire and a second break detection wire;
the first break detection wire is located at a side of the first liquid leakage detection wire away from the second liquid leakage detection wire, and the second break detection wire is located at a side of the second liquid leakage detection wire away from the first liquid leakage detection wire; and
the first break detection wire and the second break detection wire extend from the first end of the base band to the second end of the base band, and return back to the first end of the base band.

8. The liquid leakage detection band according to claim 1, wherein
the first liquid leakage detection wire is provided with a first splice sheet, and the second liquid leakage detection wire is provided with a second splice sheet;
the first splice sheet and the second splice sheet extend towards each other, and are spaced apart by a preset gap; and
the base band, the first liquid leakage detection wire and the second liquid leakage detection wire are allowed to be cut along a body of the first splice sheet and a body of the second splice sheet.

9. The liquid leakage detection band according to claim 8, wherein a cutting mark line is provided on the base band, and the cutting mark line passes through the body of the first splice sheet and the body of the second splice sheet.

10. The liquid leakage detection band according to claim 8, wherein
the first splice sheet comprises two first splice sub-sheets that are distributed along a length direction of the first liquid leakage detection wire and are spaced apart from each other, and the second splice sheet comprises two second splice sub-sheets that are distributed along a length direction of the second liquid leakage detection wire and are spaced apart from each other; and
the base band, the first liquid leakage detection wire, and the second liquid leakage detection wire (30) are allowed to be cut between the two first splice sub-sheets and between the two second splice sub-sheets.

11. The liquid leakage detection band according to claim 2, wherein
the first liquid leakage detection wire is provided with a first splice sheet, and the second liquid leakage detection wire is provided with a second splice sheet;
the first splice sheet and the second splice sheet extend towards each other, and are spaced apart by a preset gap; and
the base band, the first liquid leakage detection wire and the second liquid leakage detection wire are allowed to be cut along a body of the first splice sheet and a body of the second splice sheet.

12. The liquid leakage detection band according to claim 3, wherein
the first liquid leakage detection wire is provided with a first splice sheet, and the second liquid leakage detection wire is provided with a second splice sheet;
the first splice sheet and the second splice sheet extend towards each other, and are spaced apart by a preset gap; and
the base band, the first liquid leakage detection wire and the second liquid leakage detection wire are allowed to be cut along a body of the first splice sheet and a body of the second splice sheet.

13. The liquid leakage detection band according to claim 4, wherein
the first liquid leakage detection wire is provided with a first splice sheet, and the second liquid leakage detection wire is provided with a second splice sheet;
the first splice sheet and the second splice sheet extend towards each other, and are spaced apart by a preset gap; and
the base band, the first liquid leakage detection wire and the second liquid leakage detection wire are allowed to be cut along a body of the first splice sheet and a body of the second splice sheet.

14. The liquid leakage detection band according to claim 5, wherein
the first liquid leakage detection wire is provided with a first splice sheet, and the second liquid leakage detection wire is provided with a second splice sheet;
the first splice sheet and the second splice sheet extend towards each other, and are spaced apart by a preset gap; and
the base band, the first liquid leakage detection wire and the second liquid leakage detection wire are allowed to be cut along a body of the first splice sheet and a body of the second splice sheet.

15. The liquid leakage detection band according to claim 6, wherein
the first liquid leakage detection wire is provided with a first splice sheet, and the second liquid leakage detection wire is provided with a second splice sheet;
the first splice sheet and the second splice sheet extend towards each other, and are spaced apart by a preset gap; and
the base band, the first liquid leakage detection wire and the second liquid leakage detection wire are allowed to be cut along a body of the first splice sheet and a body of the second splice sheet.

16. The liquid leakage detection band according to claim 7, wherein
the first liquid leakage detection wire is provided with a first splice sheet, and the second liquid leakage detection wire is provided with a second splice sheet;
the first splice sheet and the second splice sheet extend towards each other, and are spaced apart by a preset gap; and
the base band, the first liquid leakage detection wire and the second liquid leakage detection wire are allowed to be cut along a body of the first splice sheet and a body of the second splice sheet.
